(19) United States
(12) Patent Application Publication
(10) Pub. No.: US 2022/0312751 A1
(43) Pub. Date: Oct. 6, 2022

(54) BOBBER STOPS FOR FISHING

(71) Applicant: Lyndon MCGILL, Salem, OR (US)

(72) Inventor: Lyndon MCGILL, Salem, OR (US)

(21) Appl. No.: 17/655,905

(22) Filed: Mar. 22, 2022

Related U.S. Application Data
(60) Provisional application No. 63/167,674, filed on Mar. 30, 2021.

(51) Int. Cl. A01K 91/03; A01K 93/00

(52) U.S. Cl. CPC A01K 91/03; A01K 93/00

(57) ABSTRACT

The disclosure features bobber stops that include a hinged body having two symmetrical halves divided by a hinge, each half including (a) a pair of line-receiving grooves, the grooves being arranged such that when the hinged body is in a closed position opposed grooves define a closed line-receiving bore, and (b) a region disposed between the grooves that is configured to clamp the line when the body is in the closed position; and a clasp configured to secure the body in the closed position and allow the body to be moved to an open position by a user.

### RELATED APPLICATIONS

This application claims priority from U.S. Provisional Patent Application No. 63/167,674, filed Mar. 30, 2021, the entire disclosure of which us incorporated herein by reference.

### BACKGROUND

Conventional clip-on bobbers or floats have long been used to keep close to the water surface and off of the bottom when bait fishing with a rod and reel. The bobber can also act as a strike indicator. While these bobbers work well in some situations, their position on the fishing line is not readily adjustable, and in some cases, for example when fishing deep water, they can make casting difficult.

Slip bobbers are designed to slide up and down the fishing line, and thus are very versatile floats. They allow the user to adapt the fishing rig to any given water depth or casting distance and work well for distance casts and for trolling bait behind a boat.

Bobber stops are small pieces of string, rubber or plastic that are positioned on the fishing line to stop the slip bobber from continuing to slide up the fishing line. Without such a stop in place, the line would simply continue to run through the bobber until the bait and hook hit the bottom. For example, as shown in FIG. 1, a slip bobber 10 can be slidingly positioned on a fishing line 12, with a bead 14 and string stopper (stop knot) 16 above the bobber and a split shot 18 below the stopper, between the stopper and the hook 20. Many other rigging options exist; FIG. 1 is simply illustrative of a rigging that includes a slip bobber and a bobber stop.

It is important that the bobber stop fit snugly on the line so that it does not slip during use, but that it also be easy for the user to move the bobber stop from one position on the line to another. It is also desirable that the bobber stop be easy to place on the line and remove from the line, features that are often lacking in conventional bobber stops. In many cases, bobber stops can only be removed from the line by removing the rest of the rigging.

### SUMMARY

The present invention features bobber stops that are easy to place on and remove from a standing portion of a fishing line (i.e., without removing the rest of the rigging and without the need for tools or gadgets). The bobber stops can also be used in other manners in addition to the standard use with sliding bobbers, e.g., to adjust the depth of floating bait, as a strike indicator, or to provide a glow-in-the-dark functionality, as will be discussed below.

In one aspect, the disclosure features a bobber stop that includes a hinged body having two symmetrical halves joined by a hinge, each half including (a) a pair of line-receiving grooves, the grooves being arranged such that when the hinged body is in a closed position opposed grooves define a closed line-receiving bore, and (b) a region disposed between the grooves that is configured to clamp the line when the body is in the closed position; and a clasp configured to secure the body in the closed position and allow the body to be moved to an open position by a user.

Some implementations may include one or more of the following optional features. The body may have a generally prolate spheroid shape, with a central circumferential flat area. The body may have a length of from about 0.4 to 0.7 inch when the bobber stop is in the closed position An inner surface of each half includes a pair of depressions, and the region configured to clamp the line comprises a rib dividing the depressions. The clasp is formed integrally with the body. The clasp includes a tab on one of the halves and a bridge member on the other half, the bridge member being configured to flex over the tab and an open area to receive the tab. The body further comprises a gripping ridge or a pair of gripping tabs positioned to assist the user in moving the body to the open position. In some cases, the gripping tabs are both positioned on one half of the body, extending from opposite edges with the clasp positioned between them. The grooves include radiused edges to prevent damage to the line. The body may be formed of a plastic material, for example one having a specific gravity of less than 1.0 such as polypropylene. If glow-in-the-dark properties are desired, the plastic material may include strontium aluminate. The plastic material may also (or instead) include a high visibility pigment. The hinge is preferably a living hinge, which may comprise a flexible web having a thickness of 0.005 inch to 0.015 inch.

In another aspect, the disclosure features methods of using the bobber stop. For example, the disclosure features a method of fishing that includes clasping a bobber stop onto a fishing line, the bobber stop comprising a hinged body having two symmetrical halves divided by a hinge, each half including (a) a pair of line-receiving grooves, the grooves being arranged such that when the hinged body is in a closed position opposed grooves define a closed line-receiving bore, and (b) a region disposed between the grooves that is configured to clamp the line when the body is in the closed position; and a clasp configured to secure the body in the closed position and allow the body to be moved to an open position by a user. The step of clasping the stop onto the line includes positioning the line in the grooves of one half, folding over the other half, and securing the clasp.

In some implementations, the method may also include any one of the following steps.

The method may further include positioning a sliding bobber on the fishing line, wherein the sliding bobber is positioned closer to a free end of the line than the bobber stop so that the bobber stop prevents upward movement of the sliding bobber on the line. The method may also include positioning the bobber stop along the length of the line so as to set the depth of floating bait secured to the line when the line is cast. The method may alternatively include utilizing the bobber stop as a strike indicator.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### DESCRIPTION OF THE DRAWINGS

FIG. 1 is a diagram of a slip bobber rig using a conventional string type bobber stop.

FIG. 2 is a perspective view of a bobber stop according to one implementation.

FIG. 3 is a perspective view of the bobber stop of FIG. 1 taken from the opposite direction.

FIG. 4 is a planar view of the inner side of the bobber stop in an open position.

FIG. 4A is similar to FIG. 4 but shows an additional optional feature.

FIG. 5 is a planar view of the back side of the bobber stop in the open position.

FIG. 6 is an end view of the bobber stop in the open position, taken from the side having the bridge member of the clasp.

FIG. 7 is an end view of the bobber stop in the open position, taken along the long side of the bobber stop.

FIG. 8 is a perspective view of the bobber stop in a closed position with a fishing line in place.

FIG. 9 is another perspective view of the bobber stop in the closed position with the fishing line shown, taken from a different angle.

FIG. 10 is a diagram showing the bobber stop in use to set the depth of floating bait.

FIG. 11 is a perspective view of a bobber stop according to another implementation, in a closed position.

FIG. 12 is a perspective view of the bobber stop shown in FIG. 11, taken from the opposite side.

FIG. 13 is a plan view of the bobber stop shown in FIG. 11.

FIG. 14 is a perspective view of the bobber stop shown in FIG. 11, with the bobber stop in an open position.

FIG. 15 is a perspective view of the open bobber stop taken from the opposite side.

FIG. 16 is a plan view of the bobber stop in the open position.

FIG. 17 is a perspective view of a bobber stop according to another implementation in the open position.

FIG. 17A is a plan view of the bobber stop shown in FIG. 17 taken from the bottom.

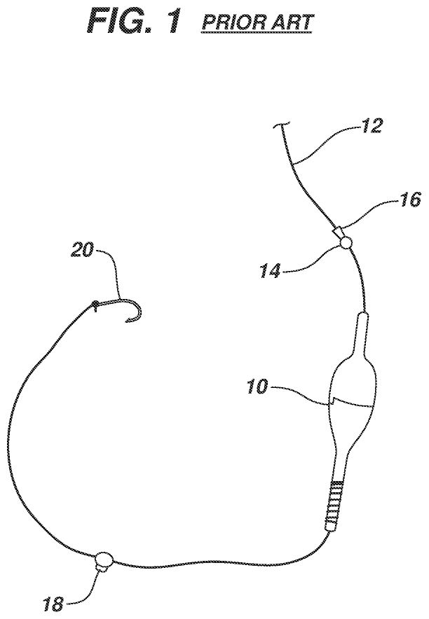

### DETAILED DESCRIPTION

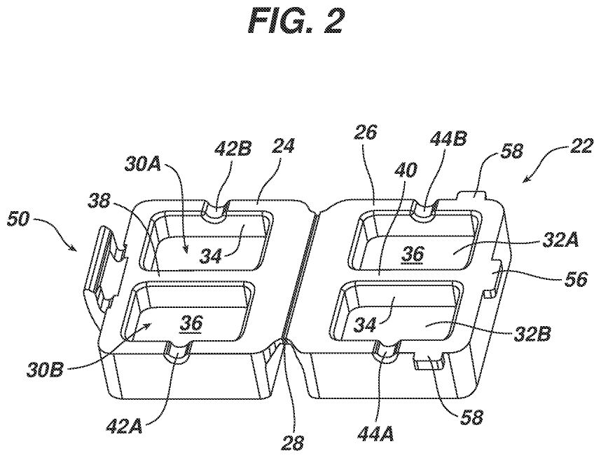

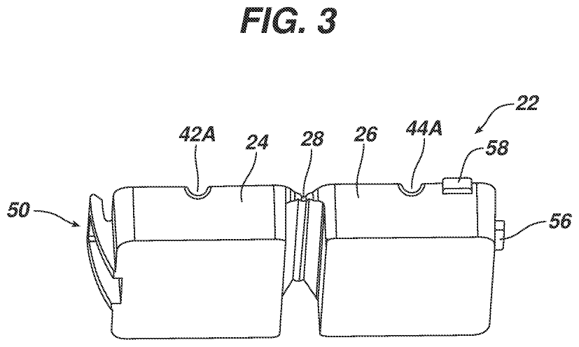

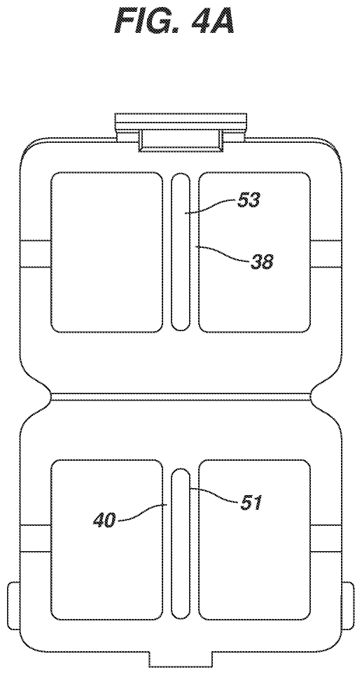

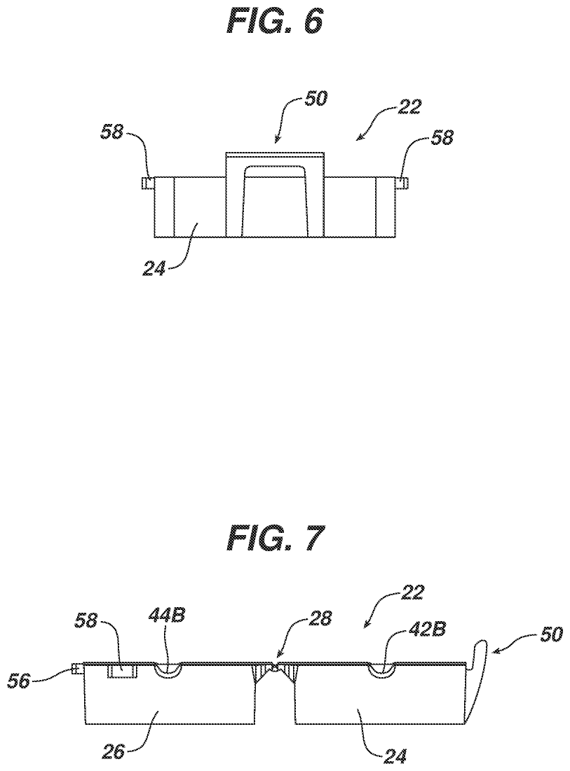

As shown in FIGS. 2-7, a bobber stop 22 has a hinged body including two halves 24, 26 joined by a living hinge 28. The body may have an overall length L in the closed position (FIG. 9) of from about 0.3 to 0.6 inch, and an overall width of from about 0.4 to 0.6 inch.

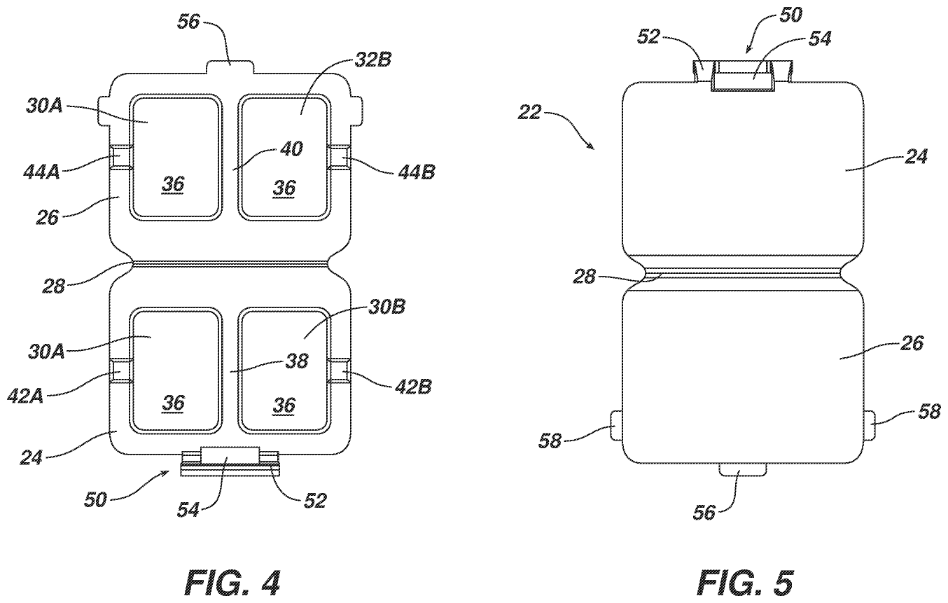

Each half includes a pair of depressions 30A and 30B and 32A and 32B on its inner side (FIGS. 2 and 4). As can be seen in FIG. 2, each depression has a side wall 34 and a floor 36. In some implementations, the side wall has a height of from about 0.05 to 0.07 inch (and thus the depression has a depth of about 0.05 to 0.07 inch.

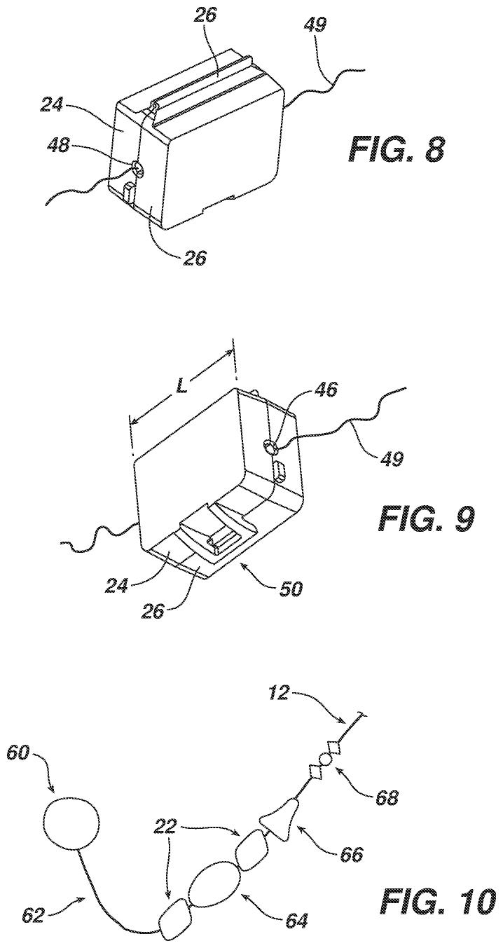

Referring to FIG. 4, the primary purpose of these depressions is to provide between them, on each half, a rib 38, 40. Each of these ribs is positioned between two grooves 42A, 42B and 44A, 44B. When the two halves of the body are closed (as shown in FIGS. 8-9) the opposed grooves 42A/44A and 42B/44B define line-receiving bores 46 and 48, respectively. The line 49 (shown in FIGS. 8-9) extends through these bores and is clamped securely by the opposed ribs 38, 40 which face each other when the body is in the closed position. The grooves have radiused edges, to prevent damage to the line if it is jerked sideways relative to the grooves, for example by a fighting fish. The dimensions of the grooves can be selected to accommodate particular line weights; in some implementations the grooves have a radius of curvature of from about 0.01 inch to 0.03 inch.

The bobber stop can optionally include features for providing a more aggressive clamping of the fishing line. For example, as shown in FIG. 4A, ridge 40 can include a raised feature (in the implementation shown, an oval ridge 51) and ridge 38 can include a corresponding recessed area (oval groove 53).

A clasp is provided to secure the two halves in the closed position around the line. The clasp has two parts, one on each half of the body. A bridge-shaped element 50 extends from body half 24 and includes an arched portion 52 having ridges on its inner surface and an open area 54 within the arched portion (FIG. 4). The open area 54 and relatively thin arched portion allows the element 50 to flex slightly during opening and closing of the clasp. A tab 56 extends from the other half, with its upper surface lying generally in the plane of the upper surface of body half 26. When the body is moved to the closed position and the clasp is engaged by the user the tab 56 fits into the open area 54 and the arched portion 52 holds it in place. The ridges help to prevent inadvertent disengagement of the arched portion and provide the user with a tactile signal that the clasp has snapped into place.

A pair of gripping tabs 58 are provided on body half 26 (the same half as the tab 56 of the clasp) to assist the user in opening the bobber stop 22. These tabs can easily be grasped between the fingers and palm while the thumb is used to lift the arched portion, for one-handed use, or the user can grasp the tabs 58 with one hand and the arched portion 52 with the other.

The bobber stop 22 can be used in any desired type of rigging. For example, as shown in FIG. 10 a pair of bobber stops 22 can be used to adjust the depth of floating bait 60 on a leader 62 when positioned on either side of a hollow lead egg sinker 64 that allows the line to slide through it. A plastic cone-shaped weed guard 66 can optionally be positioned just above the upper bobber stop 22 to help to prevent hooking weeds when reeling in a fish. A swivel 68 may be provided above the entire rigging, between the leader and the main line 12. The use of bobber stops 22 in this rigging arrangement allows the depth of the floating bait to be adjusted quickly and easily without having to change out the length of the leader.

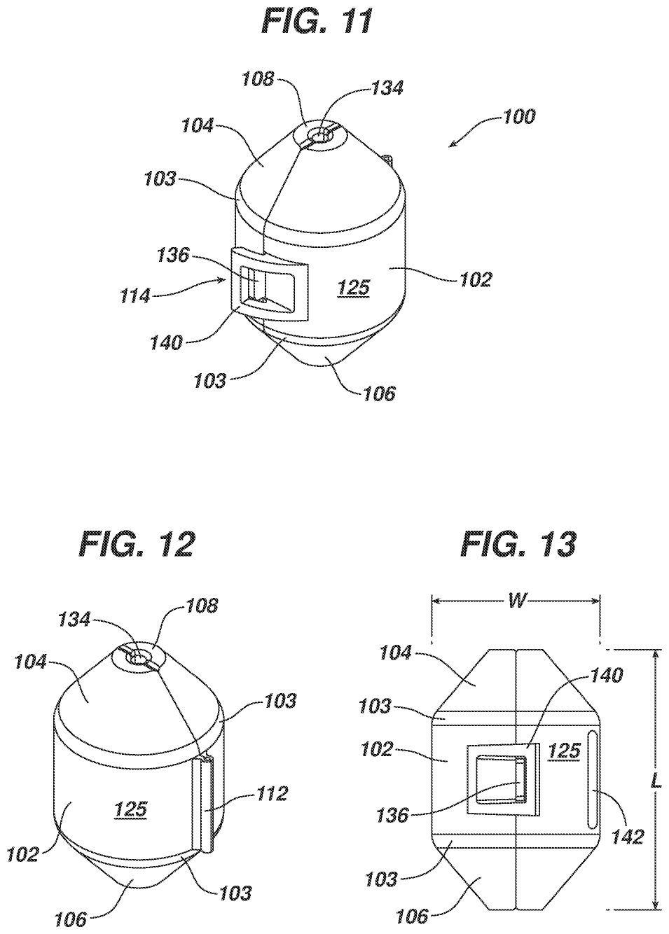

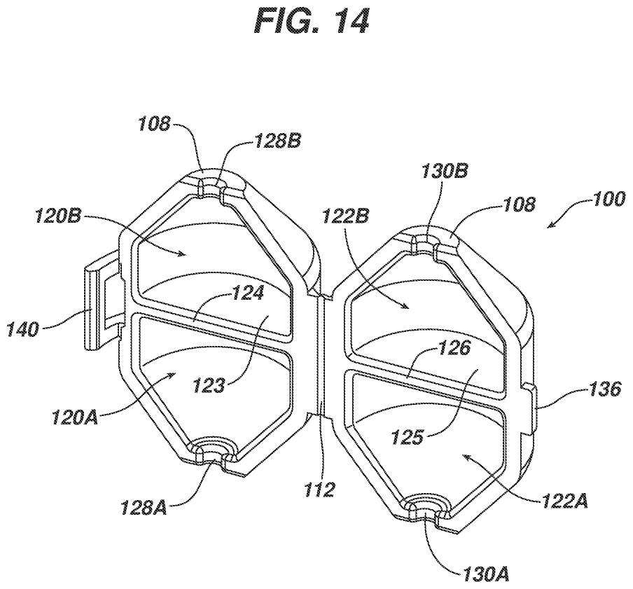

An alternative embodiment of the bobber stop is shown in FIGS. 11-13. Referring to FIG. 11, in this embodiment, bobber stop 100 has a generally “football-like” shape when in its closed position. In geometric terms, a football shape is referred to as a prolate spheroid. The shape of bobber stop 100 approximates a prolate spheroid but is somewhat different in that it includes a central belt 102 between opposite frustoconical regions 104, 106. The frustoconical regions terminate in planar cap surfaces 108 at opposite ends of the bobber stop, only one of which is visible in FIGS. 11-13. The central belt 102 is curved circumferentially, but flat when viewed in profile (FIG. 13), forming a small cylinder between the frustoconical regions. This cylindrical area provides a gripping surface for the user, and a flat area for hinge 112 and latch 114, which have the same structure as the hinge and latch in the embodiment described above. The frustoconical regions provide streamlined, hydrodynamic surfaces, to prevent entanglement of weeds on the bobber stop and to facilitate reeling in of the line against the resistance of the water. The hydrodynamic properties of the bobber stop are further enhanced by radiused transitions 103 between the frustoconical regions and the central belt 102. The hydrodynamic shape of bobber stop 100 generally eliminates the need for the weed guards to be used with the bobber stop.

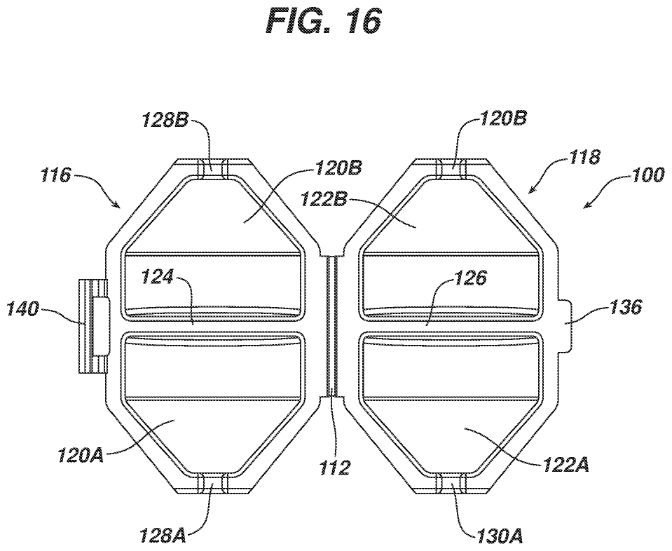

Referring to FIGS. 14-16, the interior structure of bobber stop 100 is similar to that of the first embodiment described above. Bobber stop 100 has a hinged body including two halves 116, 118 joined by hinge 112. Each half includes a pair of depressions 120A and 120B and 122A and 122B on its inner side.

The bobber stop 100 can have any desired size. In some implementations the overall length L of the body (FIG. 13) is from about 0.5 to 0.7 inch, e.g., about 0.6 to 0.65 inch while the overall width is from about 0.3 to 0.5 inch. The outer surface 125 of central belt 102 may have a radius of curvature of, for example 0.1 to 0.3 inch, e.g., 0.18 to 0.20 inch.

As discussed above with regard to the first embodiment, the depressions provide between them, on each half of the body, a rib 124, 126. In this implementation, ribs 124 and 126 are the end surfaces of a pair of half-disks 123, 125 (FIG. 14). Each of these ribs is positioned between two grooves 128A, 128B and 130A, 130B. When the two halves of the body are closed (as shown in FIG. 11) the opposed grooves define line-receiving bores 134 at opposite ends of the bobber stop, only one of which is visible in FIGS. 11-13. The line extends through these bores and is clamped securely by the opposed ribs 124, 126 which face each other when the body is in the closed position.

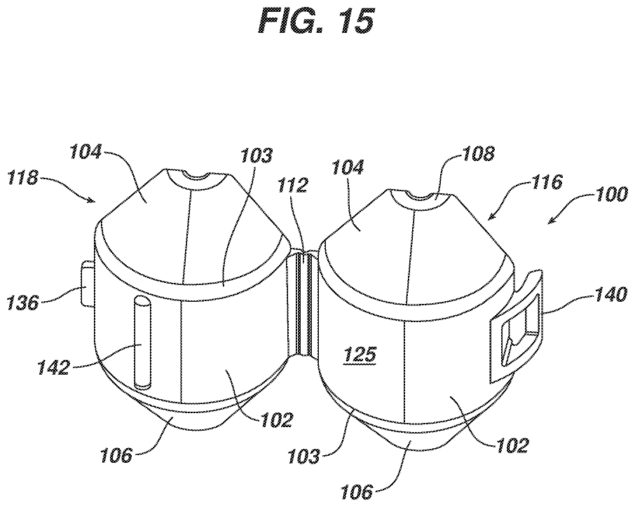

As in the first embodiment, latch 114 includes a tab portion 136 and a bridge-shaped element 140 disposed on opposite edges of the two body halves. In order to facilitate grasping of bobber stop 100 while opening and closing the latch, a gripping bar 142 (best seen in FIGS. 13 and 15) is provided on the central belt 102, extending generally parallel to the tab portion. Gripping bar 142 is raised sufficiently above the outer surface 125 of the body to enhance gripping. Other tactile features may be included to facilitate grasping of the stop if desired.

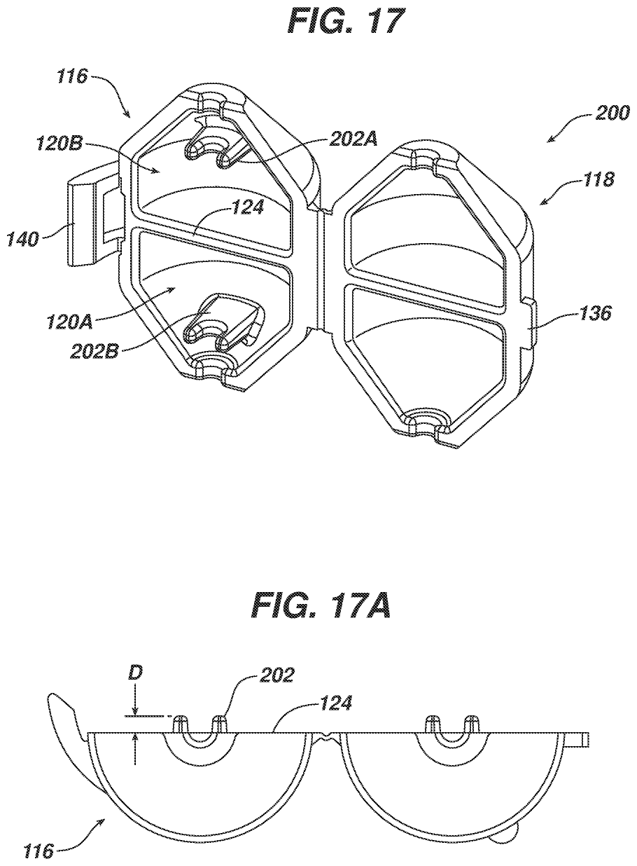

Referring to FIG. 17, bobber stop 200 is similar to that shown in FIGS. 11-16, with the addition of line guides 202A, 202B. Line guides 202A and 202B extend from the back walls of chambers 120B and 120A, respectively, of half 116 of the body. As can be seen in FIG. 17A, the line guides extend beyond the rib 124 a distance D, which may be, in some implementations, about 0.01 to 0.05 inch, e.g., about 0.02 to 0.04 inch. The line guides 202A, 202B serve to orient the line centrally in the body half 116 and hold the line in place to keep it from being pulled sideways into the hinge of the stop.

Generally, the entire bobber stop is made of one material, as an integral injection molded plastic part. In some implementations the bobber stop is formed of polypropylene homopolymer. For some applications it is preferred that the plastic selected be saltwater resistant. It is also generally preferred that the physical properties of the plastic used be such that the living hinge and the arched portion of the clasp can withstand repeated flexure, providing the bobber stop with a relatively long useful life.

Polypropylene, or other plastics having a specific gravity of less than 1 (polypropylene is 0.9) will provide the bobber stop with buoyancy. If buoyancy is not desired other plastics can be selected or fillers can be added to increase the specific gravity of the material.

In some implementations, the plastic may be filled with strontium aluminate. This will allow the bobber stop to glow in the dark or in low light conditions, such as for night fishing or fishing in the early morning or during twilight. These glow in the dark bobber stops can be used, rather than as bobber stops, as “glow bobbers”, positioned on the line above a regular clamp-on bobber. Strontium aluminate-containing bobber stops would automatically glow when light conditions get low. Luminescence could be “recharged” by holding the bobber stop in front of a UV flashlight for a minute or two.

In some implementations, the depressions in the interior of the bobber stop can be used as scent chambers to hold a fish attractant. The fish attractant would be selected so as not to compromise the gripping ability of the bobber stop on the line.

### OTHER EMBODIMENTS

A number of embodiments have been described. Nevertheless, it will be understood that various modifications may be made without departing from the spirit and scope of the disclosure.

For example, while two possible outer shapes for the bobber stop have been shown in the drawings and discussed above, other shapes could be used, for example disc or clamshell shaped.

Moreover, other types of latches and hinges may be used if desired.

Additionally, while use of the bobber stop in rod and reel fishing is disclosed above, as a bobber stop or for other purposes in rigging, the bobber stop may also be used in other types of fishing. For example, in conventional fly fishing or Tenkara rod fishing the bobber stop may be used as a strike indicator. For such uses it is desirable for the bobber stop to have a high-visibility color, such as fluorescent yellow or orange. It may also be desirable for the bobber stop to have glow-in-the dark properties, as discussed above, for fly fishing in low light conditions. In these applications the bobber stop would have the advantage of being easily applied to and removed from the line as needed.

Accordingly, other embodiments are within the scope of the following claims.

1. A bobber stop comprising:
a hinged body having two symmetrical halves joined by a hinge, each half including (a) a pair of line-receiving grooves, the grooves being arranged such that when the hinged body is in a closed position opposed grooves define a closed line-receiving bore, and (b) a region disposed between the grooves that is configured to clamp the line when the body is in the closed position; and
a clasp configured to secure the body in the closed position and allow the body to be moved to an open position by a user.

2. The bobber stop of claim 1 wherein the body has a generally prolate spheroid shape, with a central circumferential flat area.

3. The bobber stop of claim 1 wherein an inner surface of each half includes a pair of depressions, and the region configured to clamp the line comprises a rib dividing the depressions.

4. The bobber stop of claim 1 wherein the clasp is formed integrally with the body.

5. The bobber stop of claim 1 wherein the clasp includes a tab on one of the halves and a bridge member on the other half, the bridge member being configured to flex over the tab and an open area to receive the tab.

6. The bobber stop of claim 1 wherein the body further comprises a pair of gripping tabs positioned to assist the user in moving the body to the open position.

7. The bobber stop of claim 6 wherein the tabs are both positioned on one half of the body, extending from opposite edges with the clasp positioned between them.

8. The bobber stop of claim 1 wherein the grooves include radiused edges to prevent damage to the line.

9. The bobber stop of claim 1 wherein the body is formed of a plastic material.

10. The bobber stop of claim 8 wherein the plastic material has a specific gravity of less than 1.0.

11. The bobber stop of claim 9 wherein the plastic material comprises polypropylene.

12. The bobber stop of claim 9 wherein the plastic material includes strontium aluminate.

13. The bobber stop of claim 9 wherein the plastic material includes a high visibility pigment.

14. The bobber stop of claim 1 wherein the body has a length of from about 0.4 to 0.7 inch when the bobber stop is in the closed position.

15. The bobber stop of claim 1 wherein the grooves have a radius of curvature of from 0.01 to 0.03 inch.

16. The bobber stop of claim 1 wherein the hinge is a living hinge.

17. The bobber stop of claim 16 wherein the living hinge comprises a flexible web having a thickness of 0.005 inch to 0.015 inch.

18. The bobber stop of claim 3 wherein each depression includes a side wall and a floor, and the side wall has a height of from about 0.05 to 0.07 inch.

19. A method of fishing with a rod and reel, the method comprising:
clasping a bobber stop onto a fishing line, the bobber stop comprising a hinged body having two symmetrical halves divided by a hinge, each half including (a) a pair of line-receiving grooves, the grooves being arranged such that when the hinged body is in a closed position opposed grooves define a closed line-receiving bore, and (b) a region disposed between the grooves that is configured to clamp the line when the body is in the closed position; and
a clasp configured to secure the body in the closed position and allow the body to be moved to an open position by a user;
wherein clasping the stop onto the line includes positioning the line in the grooves of one half, folding over the other half, and securing the clasp.

20. The method of 19 further comprising positioning a sliding bobber on the fishing line, wherein the sliding bobber is positioned closer to a free end of the line than the bobber stop.

111. The method of claim 19 further comprising positioning the bobber stop along the length of the line so as to set the depth of floating bait secured to the line when the line is cast.
